(19) United States
(12) Patent Application Publication
(10) Pub. No.: US 2025/0124560 A1
(43) Pub. Date: Apr. 17, 2025

(54) AI-BASED VEHICLE DISK DEFECT DETECTION SYSTEM

(71) Applicant: TNSAI CO., LTD., Incheon (KR)

(72) Inventors: Suk Ho TAE, Gimpo-si (KR); Sang Hun KIM, Siheung-si (KR)

(73) Assignee: TNSAI CO., LTD., Incheon (KR)

(21) Appl. No.: 18/684,830

(22) PCT Filed: Aug. 18, 2022
(86) PCT No.: PCT/KR2022/012358

§ 371 Date: Feb. 19, 2024

(30) Foreign Application Priority Data
Aug. 20, 2021 (KR) 10-2021-0110173
Feb. 3, 2022 (KR) 10-2022-0014320

(51) Int. Cl. G06T 7/00; G06V 10/14; G06V 10/60; G06V 10/82; G06V 30/224

(52) U.S. Cl. CPC G06T 7/0004; G06V 10/14; G06V 10/60; G06V 10/82; G06V 30/224; G06T 2207/20084

(57) ABSTRACT

An artificial intelligence (AI)-based vehicle disk defect detection system according to one embodiment of the present invention may include a light emitting unit configured to project light onto a disk, which moves on a conveyor, at a certain angle, a photographing unit configured to photograph the disk moving on the conveyor and generate an image of the disk, and a determination unit configured to analyze the image using an AI-based algorithm and determine whether the disk is defective.

### TECHNICAL FIELD

The present invention relates to an artificial intelligence (AI)-based vehicle disk defect detection system, and more specifically, to an AI-based vehicle disk defect detection system in which a vehicle disk is photographed to detect whether the vehicle disk is defective, and then a captured image is analyzed based on AI to detect whether the vehicle disk is defective.

### BACKGROUND ART

Recently, interest in artificial intelligence has increased considerably due to the match between AlphaGo and 9-dan Lee Sedol. In particular, research in academia and industry on the deep learning known as the core technology of AlphaGo has increased explosively.

In order to solve known problems of artificial neural networks (that is, a vanishing problem, overfitting, and the like), an activation function (ReLU) has been developed, and algorithms like drop-out have been improved, which improves the performance of deep learning. In addition, thanks to the development of hardware such as graphics processing units (GPUs) and big data for training complex structures, deep learning has recently exhibited excellent performance in many fields.

Such deep learning technology is being developed rapidly by many overseas companies (Google LLC., Facebook Inc., Apple Inc., Microsoft Co., Alibaba Co., and Baidu Inc.) and is being applied to fields such as facial recognition, voice recognition, natural language processing, search services, and medicine. It is urgent to secure the latest technology in the rapidly developing field of deep learning, as well as to preoccupy the application field and quickly commercialize deep learning.

In defect classification methods used in conventional defect inspection equipment, algorithm developers extract features that are likely to be classified well in an image using an image processing algorithm, and then these features are learned by a classifier (support vector machine (SVM) or decision tree).

An optical device is constructed using lighting and a camera, and as a path of light changes in a defect portion, a change in an amount of light entering the camera is imaged to increase a signal-to-noise ratio (S/N ratio) of the defect portion. In such an image, a defect detection algorithm detects defect candidates, and defects are detected and classified from images of the defect candidates using a feature extraction algorithm and a classification algorithm.

Meanwhile, Korean Patent No. 10-2325347 BI (Nov. 5, 2021) discloses a machine learning-based defect classification device and method, but a defect activation map (DAM) is limited only to a generation technology. There is a need to more accurately and efficiently detect a disk defect and separate the detected defective disk in a vehicle disk production process.

### DISCLOSURE

### Technical Problem

The present invention is directed to providing an artificial intelligence (AI)-based vehicle disk defect detection system capable of more accurately detecting a defect of a vehicle disk by applying an AI technology and maximizing economic efficiency by shortening a process and production time of the vehicle disk.

The technical objects of the present invention are not limited to the above-described technical objects, and other technical objects that are not described above, will be apparent to a person having ordinary skill in the art from the specification and the accompanying drawings.

### Technical Solution

One aspect of the present invention provides an artificial intelligence (AI)-based vehicle disk defect detection system including a light emitting unit configured to project light onto a disk, which moves on a conveyor, at a certain angle, a photographing unit configured to photograph the disk moving on the conveyor and generate an image of the disk, and a determination unit configured to analyze the image using an AI-based algorithm and determine whether the disk is defective.

### Advantageous Effects

According to an artificial intelligence (AI)-based vehicle disk defect detection system according to an embodiment of the present invention, a defect of a vehicle disk can be more accurately detected by applying an AI technology, and economic efficiency can be maximized by shortening a process and production time of the vehicle disk.

The effects of the present invention are not limited to the above-describe effects, and other effects that are not described above will be apparent to a person having ordinary skill in the art from the specification and the accompanying drawings.

### DESCRIPTION OF DRAWINGS

FIG. 1 is a schematic plan view of an artificial intelligence (AI)-based vehicle disk defect detection system according to one embodiment of the present invention.

FIG. 2 is a schematic partial side cross-sectional view for describing a photographing unit of the AI-based vehicle disk defect detection system according to one embodiment of the present invention.

FIG. 3 is a schematic perspective view of a vehicle disk that is a target to be determined to be defective or non-defective in the AI-based vehicle disk defect detection system according to one embodiment of the present invention.

FIG. 4 is a conceptual view illustrating an environment in which an AI-learning vision inspection method for vision inspection using a dynamic plate is performed according to a second embodiment of the present invention.

FIG. 5 is a hardware block diagram illustrating a vision inspection device that performs the AI-learning vision inspection method for vision inspection using a dynamic plate according to the second embodiment of the present invention.

FIG. 6 is a flowchart illustrating the AI-learning vision inspection method for vision inspection using a dynamic plate according to the second embodiment of the present invention.

FIG. 7 is a flowchart illustrating a method of identifying a type of an object in the AI-learning vision inspection method for vision inspection using a dynamic plate according to the second embodiment of the present invention.

FIG. 8 is a flowchart illustrating a method of acquiring motion information in the AI-learning vision inspection method for vision inspection using a dynamic plate according to the second embodiment of the present invention.

### MODES OF THE INVENTION

Hereinafter, specific embodiments of the present invention will be described in detail with reference to the drawings. However, the spirit of the present invention is not limited to the presented embodiments, and those skilled in the art and understanding the present invention can easily accomplish retrogressive inventions or other embodiments included in the scope of the present invention by the addition, modification, and removal of components within the same scope, which are also construed as being included in the scope of the present invention.

An artificial intelligence (AI)-based vehicle disk defect detection system according to one embodiment of the present invention may include a light emitting unit that projects light onto a disk, which moves on a conveyor, at a certain angle, a photographing unit that generates an image of the disk by photographing the disk moving on the conveyor, and a determination unit that determines whether the disk is defective by analyzing the image using an AI-based algorithm.

In addition, the AI-based vehicle disk defect detection system may further include a storage unit that stores a disk determined to be non-defective by the determination unit, a discharge unit that discharges a disk determined to be defective by the determination unit, and a distinguishing unit that moves the disk that moves on the conveyor and is determined to be non-defective by the determination unit to the storage unit and moves the disk that moves on the conveyor and is determined to be defective by the determination unit to the discharge unit.

Furthermore, the determination unit may extract an identification code of a disk determined to be defective, and the distinguishing unit may recognize an identification code of a disk, compare the recognized identification code with the identification code extracted by the determination unit, and move the disk to the storage unit or discharge unit.

In addition, the distinguishing unit may include a tray unit disposed on a path between the conveyor and the storage unit, a grip unit that is positioned and moved on the tray and grips a disk, and a recognition unit that recognizes an identification code of the disk gripped by the grip unit.

Moreover, the light emitting unit may include a first light emitting unit disposed on a path of the conveyor, and a second light emitting unit disposed downstream of the first light emitting unit on the path of the conveyor, and the photographing unit may include a first photographing unit that photographs a disk that reflects light projected by the first light emitting unit, and a second photographing unit that photographs a disk that reflects light projected by the second light emitting unit.

In addition, an angle at which the first light emitting unit projects light onto the disk moving on the conveyor may be different from an angle at which the second light emitting unit projects light onto the disk moving on the conveyor.

Components with the same function within the scope of the same idea shown in the drawings of each embodiment are described using the same reference numerals.

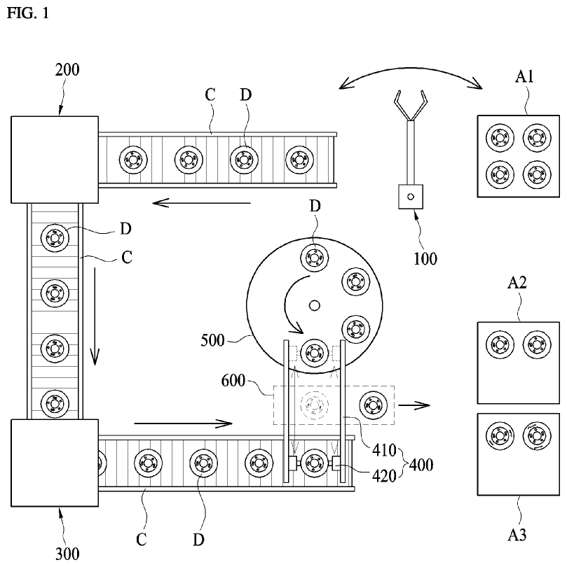

FIG. 1 is a schematic plan view of an AI-based vehicle disk defect detection system according to one embodiment of the present invention.

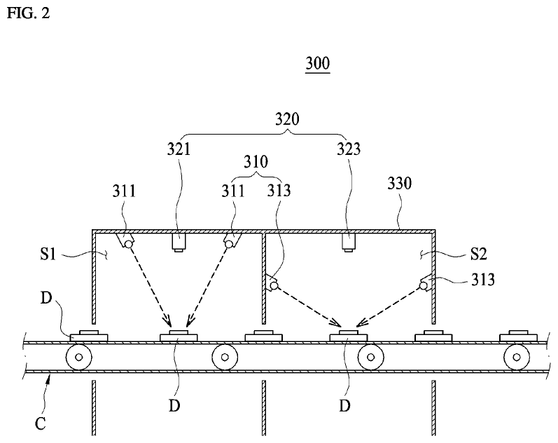

FIG. 2 is a schematic partial side cross-sectional view for describing a photographing unit of the AI-based vehicle disk defect detection system according to one embodiment of the present invention.

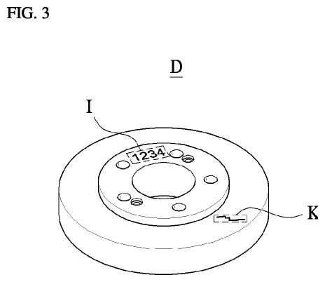

FIG. 3 is a schematic perspective view of a vehicle disk that is a target to be determined to be defective or non-defective in the AI-based vehicle disk defect detection system according to one embodiment of the present invention.

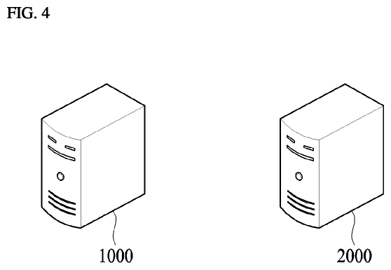

FIG. 4 is a conceptual view illustrating an environment in which an AI-learning vision inspection method for vision inspection using a dynamic plate is performed according to a second embodiment of the present invention.

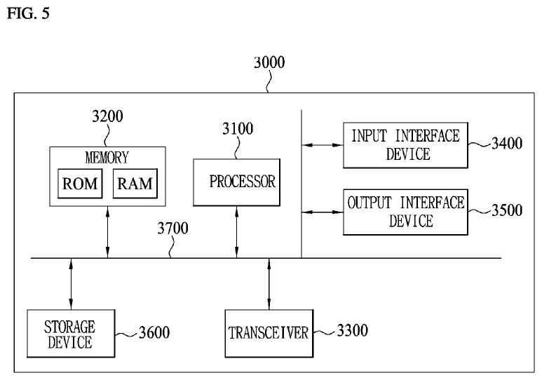

FIG. 5 is a hardware block diagram illustrating a vision inspection device that performs the AI-learning vision inspection method for vision inspection using a dynamic plate according to the second embodiment of the present invention.

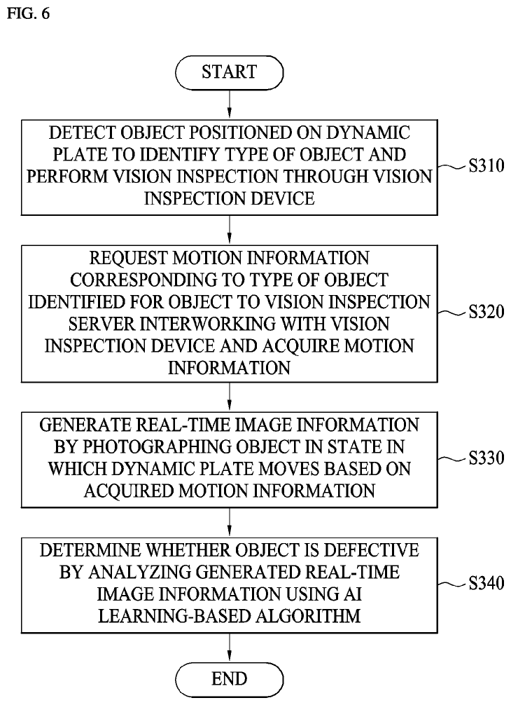

FIG. 6 is a flowchart illustrating the AI-learning vision inspection method for vision inspection using a dynamic plate according to the second embodiment of the present invention.

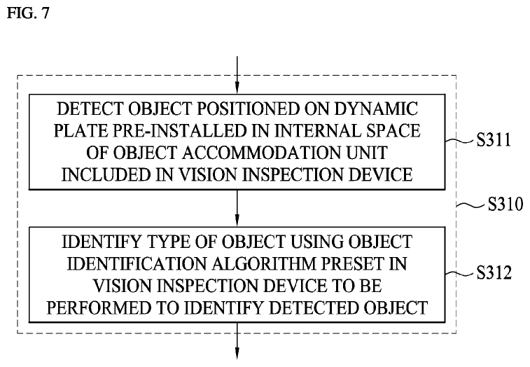

FIG. 7 is a flowchart illustrating a method of identifying a type of an object in the AI-learning vision inspection method for vision inspection using a dynamic plate according to the second embodiment of the present invention.

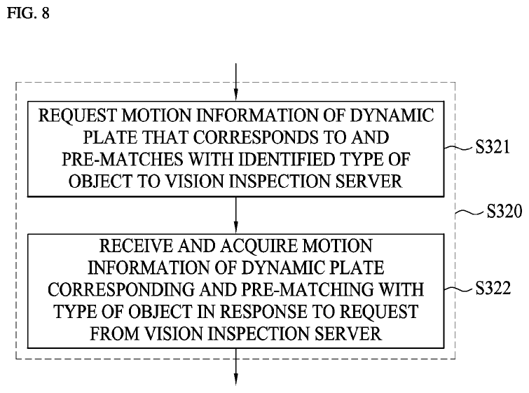

FIG. 8 is a flowchart illustrating a method of acquiring motion information in the AI-learning vision inspection method for vision inspection using a dynamic plate according to the second embodiment of the present invention.

In order to more clearly express the technical idea of the present invention, parts that are less relevant to the technical idea of the present invention or that may be easily derived by those skilled in the art are simplified or omitted.

Throughout the specification, it will be understood that when a first element is referred to as being “coupled” or “connected” to a second element, the first element can be directly coupled or electrically connected to the second element or intervening elements may be present therebetween. In addition, unless explicitly described to the contrary, “comprising” any components will be understood to imply that other elements may be included rather than excluding other elements. It should be understood that the possibility of the presence or addition of at least one feature, figure, step, operation, component, part, or combination thereof is not excluded.

As used herein, “unit” includes a unit implemented by hardware, a unit implemented by software, and a unit implemented by both hardware and software. In addition, one unit may be implemented by two or more pieces of hardware or two or more units may be implemented by one piece of hardware.

In the present disclosure, some operations or functions described as being performed by a terminal or a device may also be performed by a server connected to the corresponding terminal or device. Similarly, some of the operations or functions described as being performed by the server may also be performed by a terminal or a device connected to the corresponding server.

Hereinafter, an AI-based vehicle disk defect detection system 10 according to one embodiment of the present invention will be described with reference to FIGS. 1 to 3.

For example, the AI-based vehicle disk defect detection system 10 may be a system that detects whether a defect such as a scratch or a crack occurs in a target object using a vehicle disk D used in a vehicle brake device as the target object.

However, the target object is not limited to the vehicle disk D, and it is obvious that any target may correspond to the target object as long the target may be determined/detected to be defective or non-defective based on AI using a captured image.

However, hereinafter, for convenience of description, descriptions will be made assuming that the target object is the vehicle disk D.

Meanwhile, with reference to FIG. 1, components constituting the AI-based vehicle disk defect detection system 10 will be briefly described.

First, a first loading unit A1, on which the vehicle disk D that needs to be processed is loaded, may be disposed in a certain space of a workplace.

In addition, a second loading unit A2, on which the vehicle disk D determined to be non-defective after being processed is loaded, may be disposed, and a third loading unit A3, on which the vehicle disk D determined to be defective after being processed is loaded, may be disposed.

Furthermore, the AI-based vehicle disk defect detection system 10 may include a conveyor C that moves the vehicle disk D to a certain process.

In addition, the AI-based vehicle disk defect detection system 10 may further include a robot arm 100 that moves the vehicle disk D loaded on the first loading unit A1 to the conveyor C.

In addition, the AI-based vehicle disk defect detection system 10 may further include a processing device 200 that implements certain processing on the vehicle disk D.

For example, the processing device 200 may be a device that implements certain processing on the vehicle disk D such as heating the vehicle disk D to a certain temperature or imprinting certain information.

Meanwhile, the AI-based vehicle disk defect detection system 10 may further include a detection device 300 that detects whether the vehicle disk D processed by the processing device 200 is defective.

In addition, the AI-based vehicle disk defect detection system 10 may further include a storage unit 500 that stores the vehicle disk D determined to be non-defective by the detection device 300.

Furthermore, the AI-based vehicle disk defect detection system 10 may further include a discharge unit 600 that discharges the vehicle disk D determined to be defective by the detection device 300.

In addition, the AI-based vehicle disk defect detection system 10 may further include a distinguishing unit 400 that moves the disk D that is moved on the conveyor C and is determined to be non-defective by the detection device 300 to the storage unit 500, and moves the disk D that is moved on the conveyor C and is determined to be defective by the detection device 300 to the discharge unit 600.

That is, referring to FIG. 1, the vehicle disks D that have not been processed may be sequentially loaded on the first loading unit A1 and moved to the conveyor C by the robot arm 100.

Afterwards, the vehicle disk D moving on the conveyor C may reach the processing device 200 and may be subjected to certain processing by the processing device 200.

Next, the processed vehicle disk D may move through the conveyor C to move to the detection device 300, and the detection device 300 may determine whether the vehicle disk D is defective.

Afterwards, the processed vehicle disk D may move through the conveyor C to move to the distinguishing unit 400.

Here, the vehicle disk D determined to be defective by the detection device 300 may be moved to the discharge unit 600 by the distinguishing unit 400, and the vehicle disk D determined to be non-defective may be moved to the storage unit 500 by the distinguishing unit 400.

Afterwards, the vehicle disk D stored in the storage unit 500 may be moved to the second loading unit A2 by a device such as a robot (not shown), and the vehicle disk D stored in the discharge unit 600 may be moved to the third loading unit A3.

Hereinafter, a defect detection technology of the AI-based vehicle disk defect detection system 10 will be described in more detail.

First, referring to FIG. 3, the vehicle disk D being moved to the detection device 300 may be marked with a certain identification code I.

As an example, the identification code I may be unique identification information assigned differently for each of a plurality of vehicle disks D.

Meanwhile, unintended defects may occur in the vehicle disk D due to processing processes or the like.

For example, as shown in FIG. 3, a defect K such as a scratch or a crack may occur in the vehicle disk D.

When a defect occurs in the vehicle disk D, there is a need to accurately detect the defect because the defect may pose a major threat to durability and stability.

Therefore, the AI-based vehicle disk defect detection system 10 is intended to more accurately detect a defect in the vehicle disk D, and the defect detection technology will be described in more detail with reference to FIG. 2 below.

As an example, as shown in FIG. 2, the detection device 300 of the AI-based vehicle disk defect detection system 10 may include a light emitting unit 310 that projects light onto the disk D, which moves on the conveyor C, at a certain angle, a photographing unit 320 that generates an image of the disk D by photographing the disk D moving on the conveyor C, and a determination unit (not shown) that determines whether the disk D is defective by analyzing an image using an AI-based algorithm.

As an example, the light emitting unit 310 may be a component that projects certain light toward the vehicle disk D and may be a light-emitting diode (LED) or the like.

As an example, the photographing unit 320 may be a component that generates an image of the vehicle disk D by photographing the vehicle disk D receiving light from the light emitting unit 310 and may be a camera.

As an example, the determination unit may be a component that analyzes the image generated by the photographing unit 320 using an AI-based algorithm to determine whether the disk D is defective.

As an example, an AI-based algorithm may be generated by learning images of samples of the non-defective disk D and the defective disk D.

As a result, the determination unit may input the image as an input value to the AI-based algorithm to obtain a result value indicating whether there is a defect.

Meanwhile, as an example, the detection device 300 may further include a cover unit 330 that prevents unintended light from being projected onto the vehicle disk D moving on the conveyor C and forms a first arrangement space S1 and a second arrangement space S2 separated from the first arrangement space S1.

As an example, the cover unit 330 may form a partition wall for dividing the first arrangement space S1 and the second arrangement space S2, and a certain through-hole may be formed in the partition wall such that the vehicle disk D moving on the conveyor C may be moved from the first arrangement space S1 to the second arrangement space S2.

Here, as an example, the light emitting unit 310 may further include a first light emitting unit 311 disposed on a path of the conveyor C and a second light emitting unit 313 positioned downstream of the first light emitting unit 311 on the path of the conveyor C.

More specifically, as an example, the first light emitting unit 311 may be disposed in the first arrangement space S1 and may be fixedly positioned on the cover unit 330.

As an example, the first light emitting unit 311 may project light onto the vehicle disk D, which is moved in the first arrangement space S1 by the conveyor C, at a certain angle.

As an example, a plurality of first light emitting units 311 may be disposed in the first arrangement space S1.

In addition, the second light emitting unit 313 may be disposed in the second arrangement space S2 and may be fixedly positioned on the cover unit 330.

As an example, the second light emitting unit 313 may project light onto the vehicle disk D, which is moved by the conveyor C in the second arrangement space S2, at a certain angle.

For example, a plurality of second light emitting units 313 may be disposed in the second arrangement space S2.

Here, as an example, an angle at which the first light emitting unit 311 projects light onto the disk D moving on the conveyor C may be different from an angle at which the second light emitting unit 313 projects light onto the disk D moving on the conveyor C.

More specifically, the angle at which the first light emitting unit 311 projects light onto the disk D may be different from the angle at which the second light emitting unit 313 projects light onto the disk D. As a result, because angles of light reflected from the disk D are different, images generated by the first and second photographing units 321 and 323, which will be described below, may be diverse.

Therefore, it is possible to more accurately detect whether the disk D is defective.

Meanwhile, the photographing unit 320 may include a first photographing unit 321 that photographs the disk D reflecting light projected by the first light emitting unit 311, and a second photographing unit 323 that photographs the disk D reflecting light projected by the second light emitting unit 313.

More specifically, as an example, the first photographing unit 321 may be disposed in the first arrangement space S1 and may be fixedly positioned on the cover unit 330.

As an example, the first photographing unit 321 may generate an image of the vehicle disk D by photographing the vehicle disk D moved by the conveyor C in the first arrangement space S1.

As an example, a plurality of first photographing units 321 may be disposed in the first arrangement space S1.

In addition, the second photographing unit 323 may be disposed in the second arrangement space S2 and may be fixedly positioned on the cover unit 330.

As an example, the second photographing unit 323 may generate the image by photographing the vehicle disk D moved in the second arrangement space S2 by the conveyor C.

As an example, a plurality of second photographing units 323 may be disposed at different angles in the second arrangement space S2.

Meanwhile, the determination unit may acquire the image from the photographing unit 320 and may generate a result value indicating whether the disk D is defective through the AI-based algorithm.

Here, as an example, when the disk D is determined to be defective by analyzing the image, the determination unit may extract the identification code I marked on the disk D.

As a result, the determination unit may use the identification code I to distinguish the disk D determined to be defective from the disk D determined to be non-defective.

Meanwhile, hereinafter, the distinguishing unit 400, the storage unit 500, and the discharge unit 600 will be described in more detail with reference to FIG. 1.

As an example, the distinguishing unit 400 may be a component that moves the disk D, which moves on the conveyor C and passes the detection device 300, to the storage unit 500 and the discharge unit 600.

Here, as an example, the distinguishing unit 400 may recognize the identification code I of the disk D, compare the recognized the identification code I with the identification code I extracted by the determination unit (the identification code I of the disk D determined to be defective), and move the disk D to the storage unit 500 or the discharge unit 600.

More specifically, the distinguishing unit 400 may recognize the identification code I marked on the disk D passing the detection device 300 and may receive only the extracted identification code I of the disk D to be determined to be defective by the determination unit from the determination unit to compare the received identification code I with the recognized code I.

When, based on a specific disk D, the identification code I extracted by the determination unit is the same as the identification code I recognized by the distinguishing unit 400, the distinguishing unit 400 may move the specific disk D to the discharge unit 600.

On the other hand, when, based on a specific disk D, the identification code I extracted by the determination unit is not the same as the identification code I recognized by the distinguishing unit 400, the distinguishing unit 400 may move the specific disk D to the storage unit 500.

As a result, the distinguishing unit 400 may separately move the defective disk D and the non-defective disk D determined by the determination unit.

Here, as an example, the distinguishing unit 400 may include a tray unit 410 disposed on a path between the conveyor C and the storage unit 500, a grip unit 420 that moves on the tray unit 410 and grips the disk D, and a recognition unit (not shown) that recognizes the identification code I of the disk D gripped by the grip unit 420.

Specifically, as an example, the tray unit 410 may be a component that implements a function of a support and may be disposed to extend above the conveyor C and the storage unit 500.

As an example, a pair of supports may be disposed to face each other.

Here, as an example, the grip unit 420 may grip the disk D positioned on the conveyor C using hydraulic pressure, pneumatic pressure, or other known methods, and while gripping the disk D, the grip unit 420 may be positioned and moved on the tray unit 410.

As an example, the grip unit 420 may be moved as a rail type on the tray or may be positioned and moved by a mechanism such as a gear.

In addition, the grip unit 420 may no longer grip the gripped disk D.

Accordingly, the grip unit 420 may grip the disk D on the conveyor C and may place the disk D on the discharge unit 600 or the storage unit 500.

Meanwhile, the recognition unit may photograph the disk D gripped by the grip unit 420 and may extract the identification code I from a captured image. For example, the recognition unit may be a camera.

In addition, as an example, the recognition unit may be disposed on the grip unit 420 and moved on the tray unit 410 by the grip unit 420.

In addition, the recognition unit may recognize the identification code I of the disk D, may compare the recognized identification code with the identification code I extracted by the determination unit (the identification code I of the disk D determined to be defective), and may deliver a control command to the grip unit 420 to move the disk D to the storage unit 500 or the discharge unit 600.

As a result, the distinguishing unit 400 may move the disk D determined to be defective from the conveyor C to the discharge unit 600 and may move the disk D determined to be non-defective from the conveyor C to the storage unit 500.

Meanwhile, the storage unit 500 may rotate around a certain central axis.

Specifically, the storage unit 500 may rotate around the certain central axis to store the disk D from the distinguishing unit 400 and may provide a zone in which the disk D is not placed for the distinguishing unit 400. The distinguishing unit 400 may place the disk D on the storage unit 500 in which the disk D is not placed.

Meanwhile, whether the storage unit 500 rotates may be determined by acquiring a command on whether the storage unit 500 rotates from the distinguishing unit 400.

Specifically, when the disk D gripped on the conveyor C by the distinguishing unit 400 is the disk D determined to be defective, the distinguishing unit 400 may not command the storage unit 500 to rotate.

Conversely, when the disk D gripped on the conveyor C by the distinguishing unit 400 is the disk D determined to be defective, the distinguishing unit 400 may command the storage unit 500 to rotate so that the storage unit 500 may rotate at a preset angle to secure a space in which the disk D gripped on the distinguishing unit 400 is to be placed.

As a result, in the AI-based vehicle disk defect detection system 10 according to one embodiment of the present invention, without a decrease in process speed, whether a disk is defective may be accurately determined, and a defective disk and a non-defective disk may be very easily separated from each other.

Hereinafter, with reference to FIGS. 4 to 8, the AI-learning vision inspection method for vision inspection using a dynamic plate according to the second embodiment of the present invention will be described in detail.

An object that is a target to be subjected to a vision inspection using a dynamic plate according to the second embodiment of the present invention described below may be a manufactured product or a detailed product constituting the product that is a target to be subjected to a vision inspection.

In particular, an object described in the present invention may be a product applied to a vehicle brake or a detailed product constituting the product.

In particular, although the present invention may not necessarily be limited thereto, an object that is a target to be subjected to a vision inspection using a dynamic plate according to the second embodiment of the present invention may be a product such as a disk applied to a vehicle brake.

FIG. 4 is a conceptual view illustrating the environment in which the AI-learning vision inspection method for vision inspection using a dynamic plate is performed according to the second embodiment of the present invention.

Referring to FIG. 4, the AI-learning vision inspection method for vision inspection using a dynamic plate according to the second embodiment of the present invention may be performed based on a vision inspection device 1000 and a vision inspection server 2000. The vision inspection device 1000 and the vision inspection server 2000 may interwork with each other in advance to perform communication to transmit or receive information.

Specifically, the vision inspection device 1000 may be a device that performs a vision inspection method of checking a normal manufacturing state of an object such as a manufactured product or a detailed product constituting the product and determining whether the object is defective and may include a plurality of components (for example, components for handling functional parts) to perform the vision inspection method.

In addition, the vision inspection server 2000 may include a database storing information necessary in a process of performing the vision inspection method on an object in the vision inspection device 1000. When the vision inspection device 1000 requests the information necessary in the process of performing the vision inspection method, the necessary information may be transmitted to the vision inspection device 1000 in response to the request of the vision inspection device 1000.

Hereinafter, an example in which the vision inspection device that performs the AI-learning vision inspection method for vision inspection using a dynamic plate according to the second embodiment of the present invention described with reference to FIG. 4 may be implemented will be described in more detail with reference to FIG. 5.

FIG. 5 is a hardware block diagram illustrating a vision inspection device that performs the AI-learning vision inspection method for vision inspection using a dynamic plate according to the second embodiment of the present invention.

Referring to FIG. 5, a vision inspection device 3000 that performs the AI-learning vision inspection method using a dynamic plate may be the vision inspection device 1000 described with reference to FIG. 4, and hardware elements described with reference to the vision inspection device 1000 may not necessarily be limited to the vision inspection device. That is, although an example of the vision inspection device is described with reference FIG. 5, a hardware structure shown in FIG. 5 may also be similarly or equally applied to the vision inspection server 2000 described with reference to FIG. 4.

The vision inspection device 3000 that performs the AI-learning vision inspection method for vision inspection using a dynamic plate according to the second embodiment of the present invention may include at least one processor 3100, and a memory 3200 that stores instructions for instructing at least one processor to perform at least one operation.

Here, the at least one processor 3100 may be a central processing unit (CPU), a graphics processing unit (GPU), or a dedicated processor that performs methods according to the second embodiments of the present invention. Each of the memory 3200 and the storage device 3600 may include at least one of a volatile storage medium and a non-volatile storage medium. For example, the memory 3200 may include at least one of a read-only memory (ROM) and a random access memory (RAM).

In addition, the vision inspection device 3000 may include a transceiver 3300 that performs communication through a wireless network. Furthermore, the vision inspection device 3000 may further include an input interface device 3400, an output interface device 3500, and a storage device 3600. Respective components included in the vision inspection device 3000 may be connected through a bus 3700 to communicate with each other.

Here, at least one operation may be an operation related to the AI-learning vision inspection method for vision inspection using a dynamic plate according to the second embodiment of the present invention, and more specifically, may include an operation related to an operation method performed in the vision inspection device 3000.

Hereinafter, the AI-learning vision inspection method for vision inspection using a dynamic plate according to the second embodiment of the present invention performed in the vision inspection device 1000 and vision inspection server 2000 described with reference to FIG. 4 and the vision inspection device 3000 described with reference to FIG. 5 will be described in more detail with reference to FIGS. 6 to 8.

FIG. 6 is a flowchart illustrating the AI-learning vision inspection method for vision inspection using a dynamic plate according to the second embodiment of the present invention.

Referring to FIG. 6, the AI-learning vision inspection method for vision inspection using a dynamic plate according to the second embodiment of the present invention may be performed in the vision inspection device 1000 and vision inspection server 2000 described with reference to FIG. 4 and the vision inspection device 3000 described with reference to FIG. 5.

First, the vision inspection device may detect an object positioned on a dynamic plate to identify a type of the object and perform a vision inspection through the vision inspection device (S310).

Here, a specific method of detecting the object positioned on the dynamic plate to identify the type of the object and perform the vision inspection in the vision inspection device will be described in more detail below with reference to FIG. 7.

FIG. 7 is a flowchart illustrating a method of identifying a type of an object in the AI-learning vision inspection method for vision inspection using a dynamic plate according to the second embodiment of the present invention.

Referring to FIG. 7, the vision inspection device that performs the AI-learning vision inspection method for vision inspection using a dynamic plate according to the second embodiment of the present invention may detect the object positioned on the dynamic plate pre-installed in an internal space of an object accommodation unit included in the vision inspection device (S311).

Specifically, the vision inspection device may include the object accommodation unit in which an object that is a target to be subjected to a vision inspection may be positioned, and the dynamic plate that is an area in which an object may be positioned for a vision inspection may be pre-installed in the internal space of the object accommodation unit. In this case, the object that is the target to be subjected to the vision inspection may be detected on the dynamic plate by a user of the vision inspection device or a separate device.

For example, the vision inspection device may photograph the area of the dynamic plate, in which the object may be positioned, in real time through a photographing device (for example, a device such as a camera) included in the vision inspection device, and may generate captured real-time image information. Afterwards, the vision inspection device may detect an object on the dynamic plate by analyzing the real-time image information based on an algorithm that can identify the presence or absence of a preset object in an image or video.

In addition, the dynamic plate of the vision inspection device may include a pressure detection unit (for example, a pressure sensor), and when a preset value of pressure due to the object on the dynamic plate is detected, the vision inspection device may detect the object by determining that the object is positioned on the dynamic plate.

Thereafter, the vision inspection device may identify a type of the object using an object identification algorithm preset in the vision inspection device to be performed to identify the detected object (S312).

Here, when the object is detected on the dynamic plate, the vision inspection device may analyze real-time image information about the corresponding object using the preset object identification algorithm and thus may identify the type of the object. For example, the object identification algorithm may be an algorithm that may determine a type of an object present in an image or video to identify the type of the object.

Referring to FIG. 7 again, the vision inspection device may request motion information corresponding to the type of the object identified for the object to the vision inspection server interworking with the vision inspection device and may acquire the motion information (S320).

Here, a specific method in which the vision inspection device requests the motion information corresponding to the type of the object identified for the object to the vision inspection server interworking with the vision inspection device and acquires the motion information will be described in more detail below with reference to FIG. 8.

FIG. 8 is a flowchart illustrating a method of acquiring motion information in the AI-learning vision inspection method for vision inspection using a dynamic plate according to the second embodiment of the present invention.

Referring to FIG. 8, the vision inspection device that performs the AI-learning vision inspection method for vision inspection using a dynamic plate according to the second embodiment of the present invention may request motion information of the dynamic plate which corresponds to and pre-matches with the identified type of the object to the vision inspection server (S321).

Specifically, the vision inspection device may check a code of the object that pre-matches with the identified type of the object. Here, a type of an object may be information such as a name of an object (for example, a disk). In addition, a code of an object may be information used to identify a type of an object by matching with a type of the object and may be generated as a preset digit serial number.

That is, when there is a need to transmit or receive a type of an object in a process of transmitting or receiving information, which is necessary to perform a vision inspection, between the vision inspection device and the vision inspection server, a code of an object, which is stored by pre-matching with the type of the object, may be used.

Afterwards, the vision inspection device may use the checked code of the object to request the motion information of the dynamic plate corresponding to and pre-matching with the type of the object to the vision inspection server. Here, the vision inspection server may be the vision inspection server 2000 described with reference to FIG. 4 and may transmit or receive information by performing communication while interworking with the vision inspection device in advance as described with reference to FIG. 4.

Next, the vision inspection server may confirm the motion information of the dynamic plate, which corresponds to and pre-matches with the type of the object, from the vision inspection device. Specifically, the vision inspection server may be in a state in which motion information for each object may be pre-stored in a database for a plurality of objects that may be a target to be subjected to a vision inspection in the manner shown in Table 1 below, and the motion information may be a data set about the plurality of objects that may be a target to be subjected to the vision inspection.

TABLE 1

| | | | Illumination |
|---|---|---|---|
| Type of object | Code of object | Motion information | information |
| First type | CODE_000001 | X0001_Y0001 | LIGHT_000001 |
| Second type | CODE_000002 | X0002_Y0002 | LIGHT_000002 |
| N^{th} type | CODE_000003 | X000N_Y000N | LIGHT_00000N |

Here, a type of an object is a type of an object that is a target to be inspected, and a first type (for example, a vehicle disk) to an n^{th} type (for example, a vehicle side mirror) are different. Motion information is information about movement of the dynamic plate that moves to move an object that is a target to be inspected, and each type of object has different motion information. Illumination information is information about light that illuminates the object that is the target to be inspected moving on the dynamic plate, and each type of object has different illumination information.

First, referring to Table 1, the vision inspection server may be in a state in which a reference table for confirming motion information pre-matching with a type of an object is pre-stored in the database. A reference table such as Table 1 may include a type of an object, a code of the object, motion information, and illumination information.

The motion information stored in Table 1 may be a motion trajectory of the dynamic plate and may be generated as a value indicating a distance of motion in a vertical direction and lateral direction (for example, centimeters (cm), millimeters (mm), and inches (inch) that may indicate a distance).

In addition, the illumination information may be information referring to an intensity of light (for example, lux and candelas (cd) that may indicate an intensity of light) that may generate diffuse reflection while a corresponding object is photographed through a photographing unit of the vision inspection device in a process of performing the vision inspection on the object. When a controllable lighting unit is included in the vision inspection device, the illumination information may be transmitted along with the motion information in a process of transmitting the motion information from the vision inspection server to the vision inspection device.

Specifically, referring to Table 1, when the type of the object is the first type, a code of the corresponding object may be generated as “CODE_000001,” and motion information, which is information about a motion trajectory of the dynamic plate moving to perform a vision inspection on the corresponding object, may be generated as “X0001_Y0001.” In this case, when it is determined that the lighting unit is included in the vision inspection device requesting motion information about an object of the first type, illumination information about the corresponding object may be generated as “LIGHT_000001.” In addition, according to Table 1, when the type of the object is the second type, a code of the corresponding object may be generated as “CODE_000002,” and motion information, which is information about a motion trajectory of the dynamic plate for performing a vision inspection on the corresponding object, may be generated as “X0002_Y0002.” In this case, when it is determined that the lighting unit is included in the vision inspection device requesting motion information about an object of the second type, illumination information about the corresponding object may be generated as “LIGHT_000002.” As described above, the vision inspection server may be in a state in which a code, motion information, and illumination information of each object are pre-stored based on types of a plurality of objects. Accordingly, the vision inspection server may extract information according to a type of an object in response to a request from the vision inspection device and may transmit the extracted information to the vision inspection device to support performing a vision inspection on an object.

In this case, when a type of an object determined by the vision inspection device is the first type among types of the plurality of objects listed in Table 1, the vision inspection device may request motion information pre-matching with the first type of the object to the vision inspection server.

Thereafter, the vision inspection server may search for “X0001-Y0001,” which is the motion information pre-matching with the first type of the object, based on the request received from the vision inspection device, and may transmit the found “X0001-Y0001,” which is the motion information, to the vision inspection device.

In this case, the vision inspection server may also receive information about whether the lighting unit is included in the vision inspection device in a process of receiving the request for the motion information from the vision inspection device, and when it is determined that the lighting unit is included in the vision inspection device, the illumination information may be transmitted to the vision inspection device along with the motion information.

Thereafter, the vision inspection device may receive and acquire the motion information of the dynamic plate corresponding to and pre-matching with the type of the object in response to the request from the vision inspection server (S322).

In this case, the vision inspection device may check the code of the object, which corresponds to and pre-matches with the motion information, received from the vision inspection server, and may compare the checked code of the object with a code of an object used in a process of requesting motion information, thereby determining whether a response corresponding to the request transmitted from the vision inspection device is received.

For example, when the code of the object used in the vision inspection device to request motion information is “CODE_000001” which is an object code of the first type of the object listed in Table 1, it is possible to confirm whether the code of the object, which corresponds to and pre-matches with the motion information received from the vision inspection server is the same as “CODE_000001” which is the object code of the first type of the object.

Afterwards, when the code of the object, which corresponds to and pre-matches with the motion information, received from the vision inspection server is the same as “CODE_000001,” the vision inspection device may determine that the response corresponding to the request transmitted from the vision inspection device is received normally.

On the other hand, when the code of the object, which corresponds to and pre-matches with the motion information, received from the vision inspection server is not the same as “CODE_000001,” the vision inspection device may determine that the response corresponding to the request transmitted from the vision inspection device is not received normally. In this case, the vision inspection device may request motion information about the first type of the object to the vision inspection server again.

Referring to FIG. 6 again, the vision inspection device that performs the AI-learning vision inspection method for vision inspection using a dynamic plate according to the second embodiment of the present invention may generate real-time image information on the object by photographing the object in a state in which the dynamic plate moves based on the acquired motion information (S330).

Specifically, in order to generate the real-time image information, through the photographing unit included in the vision inspection device, the vision inspection device may control the dynamic plate so that the dynamic plate moves based on the motion trajectory indicated by the motion information. In this case, the dynamic plate of the vision inspection device may be accompanied by the object that is the target to be subjected to the vision inspection.

Thereafter, the vision inspection device may photograph the object positioned on the moving dynamic plate through the photographing unit (for example, a device such as a camera) included in the vision inspection device and thus may generate the real-time image information used for analysis for the vision inspection of the object.

Here, the real-time image information generated by the vision inspection device may be information related to an image or video formed at an angle at which an object is photographed by the photographing unit to generate diffuse reflection due to the movement of the dynamic plate. That is, when an object is photographed using the photographing unit, the real-time image information may be image information about the object photographed in a state in which diffuse reflection occurs.

That is, the vision inspection device may move the dynamic plate such that the object is photographed in a state in which information related to an image or video corresponding to the real-time image information acquired through the imaging unit reflects diffuse reflection of light. In this case, the vision inspection device may generate the real-time image information by photographing after all motions of the dynamic plate are completed (for example, when the motion is completed based on the motion trajectory corresponding to the motion information). In addition, the vision inspection device may also generate the real-time image information by photographing while the dynamic plate is moving.

Afterwards, the vision inspection device may determine whether the object is defective by analyzing the generated real-time image information using an AI learning-based algorithm (S340).

Specifically, the vision inspection device may perform a vision inspection on the object based on an AI learning algorithm that is pre-trained based on learning information related to the vision inspection included in the real-time image information.

For example, learning information may be information related to an inspection result of a vision inspection for each type of object among a plurality of objects. In this case, the vision inspection for each type of object may be a vision inspection performed in a state in which a plurality of different conditions are applied.

Here, the plurality of conditions applied to the vision inspection may include an average intensity of light generated while a vision inspection is performed on an object, an angle that generates diffuse reflection, an amount of diffuse reflection generated by a surface of the object, and a degree of transparency of each surface included in the object accommodation unit. The vision inspection device may perform the vision inspection on the object based on the AI learning algorithm pre-trained based on the above learning information and thus may determine whether the object is defective.

In particular, when the real-time image information is information related to an image, the vision inspection device may generate a plurality of image frames based on the information related to the image in a preset time unit. Thereafter, the vision inspection device may analyze the real-time image information to perform the vision inspection on the object based on the AI algorithm pre-trained with the plurality of generated image frames.

Meanwhile, the vision inspection device may photograph a process of performing the vision inspection on the object using the photographing unit included in the vision inspection device and thus may generate real-time image information about the process of performing the vision inspection. Thereafter, the vision inspection device may output a process and result of the vision inspection through an output unit included in the vision inspection device to provide the process and result of the vision inspection to a user of the vision inspection device.

In other words, the vision inspection device may include output units such as a monitor and a screen and may output and provide a process of a vision inspection for an object, which is photographed through the photographing unit such as a camera, through the output unit to be confirmed.

Meanwhile, an algorithm for identifying, searching for, and detecting an object used in the AI-learning vision inspection method for vision inspection using a dynamic plate according to the second embodiment of the present invention may be a you-only-look-once (YOLO) algorithm.

Specifically, the YOLO algorithm may be an algorithm that detects an object based on a single stage method and may divide a frame of an image or a plurality of frames constituting a video into areas with the same size (for example, a grid).

Afterwards, according to the YOLO algorithm, the number of bounding boxes designated in a predefined shape centered on the center of each area may be predicted, and reliability may be calculated based on the predicted number.

In this case, the vision inspection device that performs the YOLO algorithm may select an area with relatively high reliability based on preset criteria for whether an object is included in a frame of an image or a plurality of frames constituting a video and may identify of a type of an object for the selected area.

An example in which the vision inspection device that performs the AI-learning vision inspection method for vision inspection using a dynamic plate according to the second embodiment of the present invention uses the YOLO algorithm has been described, but the present invention may not necessarily be limited thereto.

In other words, in the vision inspection device that performs the AI-learning vision inspection method for vision inspection using a dynamic plate according to the second embodiment of the present invention, in addition to the YOLO algorithm, algorithms that may be used to detect or identify an object may include a convolutional neural network (CNN)-based object detection algorithm and an SAS deep learning-based object detection algorithm.

Meanwhile, as described above with reference to FIGS. 4 to 8, the vision inspection device that performs the AI-learning vision inspection method for vision inspection using a dynamic plate according to the second embodiment of the present invention may acquire real-time image information on an object by photographing the object that is a target to be subjected to a vision inspection, may move the dynamic plate according to a type of an object to generate as much diffuse reflection as possible according to the type of the object during photographing of the object, and may adjust an average intensity of light, an angle that generates diffuse reflection, or the like according to the type of the object.

Afterwards, for real-time image information about an object acquired in a state in which diffuse reflection is generated, the vision inspection device may determine whether the object is defective by analyzing the real-time image information about the object based on an AI learning algorithm pre-trained based on AI, thereby obtaining an effect of performing an accurate vision inspection instead of the user's naked eye.

In other words, the vision inspection device that performs the AI-learning vision inspection method for vision inspection using a dynamic plate according to the second embodiment of the present invention may generate diffuse reflection using an angle at which an object is photographed based on the dynamic plate to create a situation similar or identical to the user's naked eye, and may determine whether an object is defective using an AI learning-based algorithm trained based on AI such that the vision inspection method may be similar or identical to a method in which a user directly determines whether an object is defective.

Methods according to the present invention may be implemented with program instructions which may be executed by various computers and may be recorded in computer-readable media. The computer-readable media may include, alone or in combination with the program instructions, data files, data structures, and the like. The program instructions recorded in the computer-readable media may be designed and configured especially for the present invention or may be known and available to those skilled in computer software.

Examples of the computer-readable media may include hardware devices specifically configured to store and execute program instructions, such as a ROM, a RAM, a flash memory, and the like. Examples of the program instructions may include a machine code such as that produced by a compiler as well as a higher level code that may be executed by a computer using an interpreter or the like. The above-described hardware devices may be provided to operate as one or more software modules in order to perform the operations of the present invention, or vice versa.

In addition, all or some components or functions of the above-described method or device may be implemented in combination or separately.

The configurations and characteristics of the present invention have been described above on the basis of the embodiments according to the present invention, but the present invention is not limited thereto. Various modifications or changes within the spirit of the invention will be obvious to those skilled in the art. Therefore, such modifications or changes are within the scope of the claims.

1. An artificial intelligence (AI)-based vehicle disk defect detection system comprising:
a light emitting unit configured to project light onto a disk, which moves on a conveyor, at a certain angle;
a photographing unit configured to photograph the disk moving on the conveyor and generate an image of the disk; and
a determination unit configured to analyze the image using an AI-based algorithm and determine whether the disk is defective.

2. The AI-based vehicle disk defect detection system of claim 1, further comprising:
a storage unit configured to store the disk determined to be non-defective by the determination unit;
a discharge unit configured to discharge the disk determined to be defective by the determination unit; and
a distinguishing unit configured to move the disk, which is moved on the conveyor and is determined to be defective by the determination unit, to the storage unit and move the disk, which is moved on the conveyor and is determined to be defective by the determination unit, to the discharge unit.

3. The AI-based vehicle disk defect detection system of claim 2, wherein the determination units extract an identification code of the disk determined to be defective, and
the distinguishing unit recognizes an identification code of the disk, compares the recognized identification code with the identification code extracted by the determination unit, and moves the disk to the storage unit or the discharge unit.

4. The AI-based vehicle disk defect detection system of claim 3, wherein the distinguishing unit includes:
a tray unit disposed on a path between the conveyor and the storage unit;
a grip unit which moves on the tray and grips the disk; and
a recognition unit configured to recognize the identification code of the disk gripped by the grip unit.

5. The AI-based vehicle disk defect detection system of claim 2, wherein the light emitting unit includes a first light emitting unit disposed on a path of the conveyor, and a second light emitting unit disposed downstream of the first light emitting unit on the path of the conveyor, and
the photographing unit includes a first photographing unit configured to photograph the disk that reflects light projected by the first light emitting unit, and a second photographing unit configured to photograph the disk that reflects the light projected by the second light emitting unit.

6. The AI-based vehicle disk defect detection system of claim 5, wherein an angle at which the first light emitting unit projects light onto the disk moving on the conveyor is different from an angle at which the second light emitting unit projects light onto the disk moving on the conveyor.
